(19) United States
(12) Patent Application Publication
(10) Pub. No.: US 2024/0418550 A1
(43) Pub. Date: Dec. 19, 2024

(54) Performance monitor for ultrasonic transducer

(71) Applicant: Antonio Davido Trigiani, Bristol, TN (US)

(72) Inventor: Antonio Davido Trigiani, Bristol, TN (US)

(21) Appl. No.: 18/741,080

(22) Filed: Jun. 12, 2024

Related U.S. Application Data
(60) Provisional application No. 63/472,925, filed on Jun. 14, 2023.

(51) Int. Cl. G01F 1/667; G01F 1/66

(52) U.S. Cl. CPC G01F 1/668; G01F 1/662

(57) ABSTRACT

Apparatus for performance monitoring an ultrasonic transducer that includes a piezoelectric element and at least one block. The performance monitor including a sensor, a conditioner and a processor. The sensor is acoustically coupled to the block and measures parameters related to the ultrasonic vibrations from the piezoelectric element through the block. The conditioner has in input connected to the sensor and provides an output suitable for the processor. The conditioner output includes data on the measured frequency and amplitude. The processor executes a process that includes measuring parameters when the transducer is excited, and determining if an event has occurred. An event occurs when a parameter is outside specified criteria. When too many events occur, an error is indicated.

### BACKGROUND

### 1. Field of Invention

This invention pertains to a performance monitor for an ultrasonic transducer such as transducers used for algae control in bodies of water. More particularly, this invention pertains to a sensor and system that monitors the transmission capabilities, including the interface, of an ultrasonic transducer.

### 2. Description of the Related Art

Ultrasonic algae control systems are used to control the undesirable growth of algae in bodies of water. Ultrasonic algae control systems include a sonic head that is submerged in a body of water. The sonic head includes one or more ultrasonic transducers that direct ultrasonic waves into the water.

It is known to generate ultrasonic waves from ultrasonic transducers that incorporate a piezoelectric crystal. Blocks are attached to the crystal to enhance the transmission of the ultrasonic waves into fluid, such as water, from the crystal. One type of transducer uses a single block attached to one face of the crystal. Another type uses two blocks, each attached to an opposing face of the piezoelectric crystal. The blocks are affixed to the crystal in various ways, for example, by adhesives or by a fastener that compresses the crystal against the one or more blocks.

One failure mode is the interface between the piezoelectric crystal and the one or more blocks. Another failure mode is fracturing of the piezoelectric crystal. Either of these failure modes results in a reduction of the emitted amplitude of the signals originating from the piezoelectric crystal. The transducers are deployed in fluid, typically underwater, such as in ponds, lakes, canals, pools, tanks, sea-chests, and vessel hulls. Because of the often remote and inaccessible locations, periodic inspections and maintenance of the transducers is difficult and rarely performed.

### BRIEF SUMMARY

According to one embodiment of the present invention, a performance monitor for an ultrasonic transducer is provided. The performance monitor is configured to monitor the performance of an ultrasonic transducer. The ultrasonic transducer includes a piezoelectric crystal with at least one block of metal affixed to the crystal. Generally, the piezoelectric crystal is secured to the one or more blocks. For example, one such type of transducer has a single block attached to a surface of a disc-shaped crystal. Another example of such type of transducer has a block attached to opposing surfaces of the crystal. Yet another example of a type of ultrasonic transducer includes a donut-shaped piezoelectric crystal that includes a pair of blocks on opposing sides of the crystal. A fastener passes through the center of the donut-shaped crystal and secures the two blocks to the faces of the crystal.

The performance monitor includes a sensor responsive to ultrasonic vibrations from a block, a piezoelectric signal conditioner, and a processor. The sensor is responsive to the ultrasonic mechanical energy transmitted from the crystal to the block. The sensor is also responsive to the ultrasonic mechanical energy transmitted from the block to the sensor, either directly or indirectly. The sensor produces an electrical output that is received by the conditioner, which conditions the sensor output to produce a conditioner output that corresponds to the sensor output. The conditioner output is sent to a processor.

The processor stores data corresponding to the sensor output, along with data relating to the ultrasonic transducer, such as excitation frequency and power at the time of the sensor measurement. The processor stores this data and compares it to previously stored data to determine if there is a degradation of the performance of the transducer, for example, a degradation of the crystal to block interface monitored by the sensor. Degradation is typically either gradual, as indicated by a trend in the historical data, or catastrophic, as indicated by a significant step decrease in sensor output.

The processor executes steps of a process for monitoring the performance of the transducer. When the transducer is excited, the sensor measures amplitude and frequency. The excitation frequency is known by the processor. The processor compares the excitation frequency to the measured frequency to determine if they match within specified criteria. If the frequencies do not match, an event is recorded. The excitation frequency is used to look up reference values from a data table. The data table contains information on a specific sensor configuration, including an amplitude and a frequency. The processor compares the measured amplitude to the amplitude stored in the data table for the specific excitation frequency to determine if they match within specified criteria. If the amplitudes do not match, an event is recorded. If the number of recorded events equals or exceeds a predetermined number, an error is indicated. In one embodiment, recorded events expire after a predetermined time, for example, 24 hours, such that an error only occurs when a predetermined number of events occurs within that predetermined period.

The sensor is a piezoelectric crystal that is acoustically coupled to a block that is acoustically coupled to the ultrasonic transducer crystal. In one embodiment, the sensor is attached to a surface of the block, such as with an adhesive. In another embodiment, the sensor has a donut-shape in which a fastener passes through the sensor hole and secures the sensor to a surface of the block. In yet another embodiment, the sensor has a disc-shape that slides into a slot in the block. For example, a slot is machined in the surface of the block and the sensor is bonded to the block after the sensor is slid into the slot. In still another embodiment, the sensor has a disc-shape and is attached to an interior surface of a housing enclosing the block. The housing is filled with a potting compound that acoustically couples the sensor to the block.

The conditioner, in various embodiments, includes multiple stages or circuits that convert the output of the sensor into a signal suitable for the processor to receiver. In one embodiment, the conditioner includes a buffer, an amplifier, a level-shifting circuit, a frequency discriminator, and an analog-to-digital converter (ADC). The conditioner provides a digital signal to the processor of the measured frequency and amplitude. In another embodiment, the frequency discriminator and ADC are functionally incorporated in the processor.

The processor, in one embodiment, is a microcontroller that executes software that performs the functions of the performance monitor. One function is to collect and store sensor data, which, with the passage of time, becomes historical data. Another function is to compare the current data to the historical data to determine the performance of the ultrasonic transducer interface the sensor is monitoring. Yet another function is to identify and record variance events and determine a course of action based on the number of events. The processor sends messages to annunciate the state of health of the overall device.

In one embodiment, before deployment of the performance monitor, data is collected for the sensor and transducer configuration. The initial data is stored in a data table, such as during manufacturing, and is used for comparison during monitoring after deployment of the monitor. In such an embodiment, during use after deployment, for each discrete frequency at which the ultrasonic transducer is excited, the sensor output is compared to the ultrasonic transducer excitation frequency. If an anomaly is detected, such as a mismatch between the sensed frequency and the excitation frequency, an event is recorded. The event record includes the event time and date, as-measured data, and the desired data. If the frequencies match, the amplitude measured by the sensor is compared to the stored amplitude data for that frequency. If a deviation is detected, then an event is recorded. If the number of events exceeds a preselected number of events, then an error is indicated.

### BRIEF DESCRIPTION OF THE SEVERAL VIEWS OF THE DRAWINGS

The above-mentioned features will become more clearly understood from the following detailed description read together with the drawings in which:

FIG. 1 is a block diagram showing the configuration of the performance monitor and the ultrasonic transducer.

FIG. 2 is a block diagram showing one embodiment of the piezoelectric signal conditioner.

FIG. 3 is a flow diagram one embodiment of the process for creating a data table.

FIG. 4 is a flow diagram one embodiment of the process for monitoring performance of an ultrasonic transducer.

FIG. 5 is a side view of one embodiment of an ultrasonic transducer showing a first embodiment of a sensor arrangement with a pair of sensors each coupled to a side face of a block.

FIG. 6 is an exploded view of the embodiment of FIG. 5.

FIG. 7 is a perspective, exploded view of a second embodiment of a sensor arrangement with a sensor coupled to a rear face of a block.

FIG. 8 is a perspective, exploded view of a third embodiment of a sensor arrangement with a sensor coupled to a side face of a block.

FIG. 9 is a perspective, exploded view of a fourth embodiment of a sensor arrangement with a sensor coupled inside a block.

FIG. 10 is an exploded view of a fifth embodiment of a sensor arrangement with a pair of sensors positioned adjacent the outer faces of the blocks of the transducer.

FIG. 11 illustrates an exploded view of the fifth embodiment of a sensor arrangement along with a transducer and a transducer housing.

### DETAILED DESCRIPTION

Apparatus for a performance monitor for an ultrasonic transducer is disclosed. The performance monitor is generally indicated as 100. Various components are illustrated both generically and specifically in the figures and in the following description. For example, the sensor 102-1A, 102-1B, 102-2B, 102-3B are discussed individually and separately to ensure clarity when describing the configuration of each sensor 102-1A, 102-1B, 102-2B, 102-3B. The sensor 102, when referred to collectively, is referenced without the alphanumeric suffix. Another example is the block 504, which when referred to collectively, is referenced without an alphanumeric suffix. The first and second blocks 504-A, 504-B are referenced without respect to embodiment by omitting the numeric suffix that corresponds to a particular embodiment of the monitor 100. The blocks 504-1A, 504-1B, 504-2B, 504-3B, 504-4B, 504-5A, 504-5B, when referenced to a specific location and configuration, are referenced with both the embodiment and position suffix.

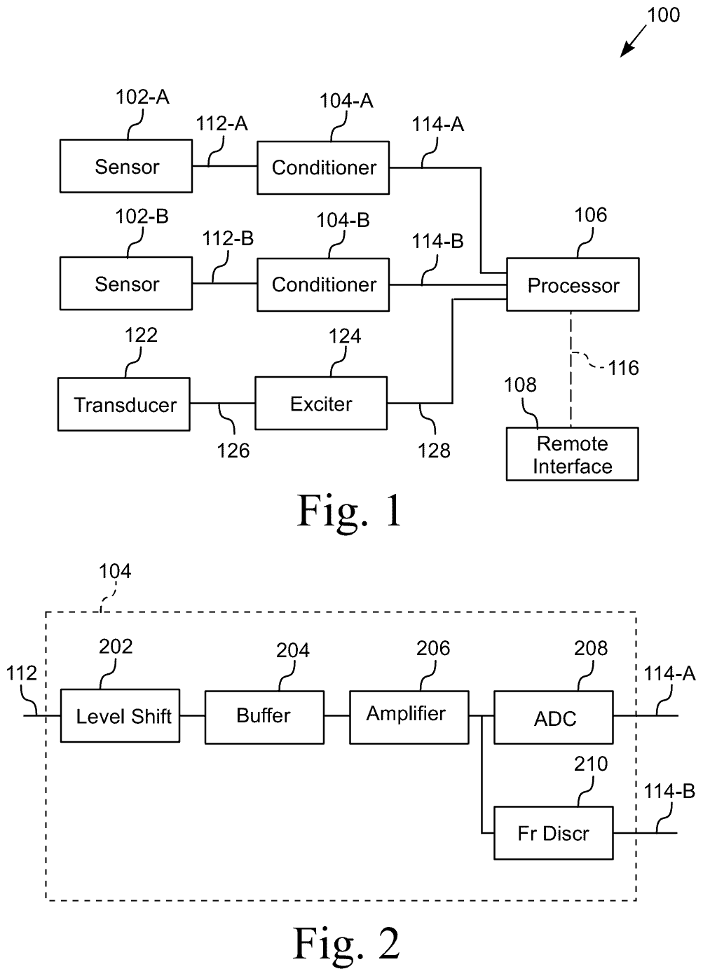

FIG. 1 illustrates a block diagram showing the configuration of the performance monitor 100 and the ultrasonic transducer 122. The illustrated embodiment of the performance monitor 100 includes a pair of sensors 102-A, 102-B, a pair of conditioners 104-A, 104-B, and a processor 106.

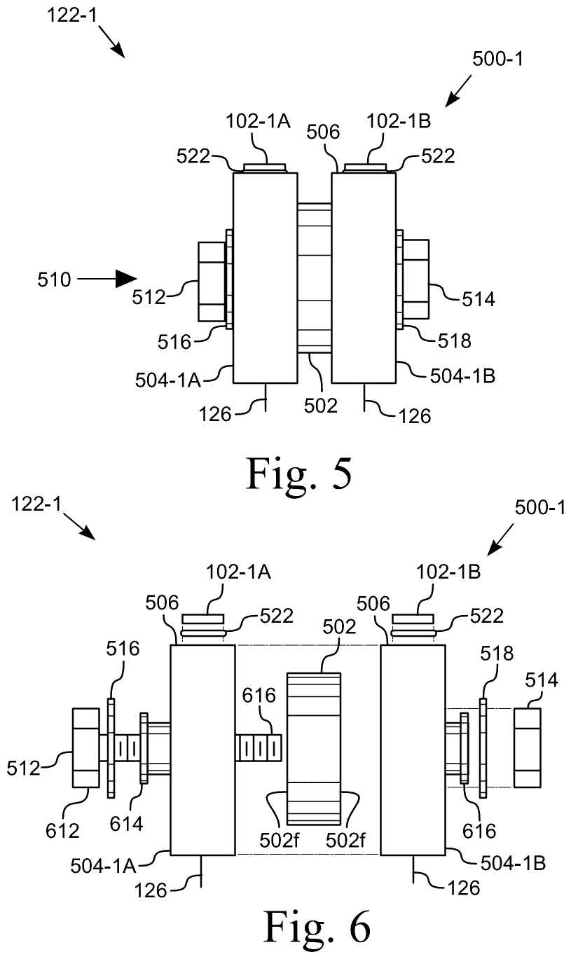

The performance monitor 100 is configured to monitor a transducer 122 that is connected to an exciter 124 connected to the processor 106. The transducer 122 is the type such as illustrated in FIG. 5 with a piezoelectric crystal 502 sandwiched between two blocks 504-1A, 504-1B. The transducer 122 is electrically connected to an exciter 124 via transducer conductors 126. The exciter 124 is electrically connected via exciter conductors 128 to an output of the processor 106. The processor 106 is connected to a remote interface 108. The connection 116 between the processor 106 and the remote interface 108 is via a wired connection and/or a wireless connection.

As used herein, the processor 106 is broadly construed to be a computer, microprocessor, or microcontroller that stores data, executes a program, and communicates with external devices such as the conditioners 104-A, 104-B, the exciter 124, and the remote interface 108. In one embodiment, the processor 106 is a self-contained device that performs the necessary functions. In another embodiment, the processor 106 includes discrete components that are interconnected to perform the necessary functions.

In one embodiment, the sensors 102 are piezoelectric crystals that are sensitive to vibrations from the transducer 122. Each sensor 102-A, 102-B is acoustically coupled, either directly or indirectly, to the transducer 122 such that each sensor 102-A, 102-B monitors the performance of an associated interface between the crystal 502 and the block 504. That is, each sensor 102 is responsive to vibrations from the transducer 102. In various embodiments, the sensor 102 is directly coupled to a block 504. In other embodiments, the sensor 102 is indirectly coupled by the sensor 102 being attached or coupled to a housing 1102 or other structure that is acoustically coupled to the transducer 102. The sensors 102 are each electrically connected via sensor conductors 112-A, 112-B to a conditioner 104. In one embodiment, the sensor conductors 112-A, 112-B for each sensor 102-A, 102-B includes two wires from each sensor 102-A, 102-B.

Each conditioner 104-A, 104-B is electrically connected via conditioner conductors 114-A, 114-B to an input of the processor 106. In another embodiment, the transducer 122 is configured with only a single block 504 such that ultrasonic waves are emitted from only one side of the crystal 502. In such an embodiment, only one sensor 102 and one conditioner 104 are used to monitor the performance of the one interface between the crystal 502 and the block 504.

In one embodiment, the sensors 102-A, 102-B, the conditioners 104-A, 104-B, the transducer 122, the exciter 124, and the processor 106 are integrated into a single sonic head that is submerged in a body of water. In one such embodiment, the sonic head also includes multiple transducers 122 and exciters 124, with corresponding performance monitoring system 100 components for the multiple transducers 122.

FIG. 2 illustrates a block diagram showing one embodiment of the piezoelectric signal conditioner 104. The illustrated embodiment of the conditioner 104 includes a buffer 204, an amplifier 206, a level shift circuit 202, an analog-to-digital converter (ADC) 208, and a frequency discriminator 210. The conditioner 104 receives an input 112 from the sensor 102. The conditioner 104 has outputs 114-A, 114-B received by the processor 106. The outputs 114-A, 114-B are digital signals of the amplitude from the ADC 208 and the frequency from the frequency discriminator 210.

The illustrated embodiment of the conditioner 104 includes a level shift circuit 202 with an input directly connected to the sensor 102 and an output driving the buffer 204. The output 112 of the sensor 102 is an alternating current (ac) signal with the frequency determined by the mechanical vibrations detected by the sensor 102 and the amplitude determined by the intensity of those detected vibrations. The ac signal varies between a positive voltage and a negative voltage. The level shift circuit 202 converts the amplified alternating current signal such that the output from the level shift circuit 202 is a voltage that varies between zero volts and a voltage equal the sum of the positive voltage and the absolute value of the negative voltage. In another embodiment, the level shift circuit 202 is connected between the buffer 204 and the amplifier 206. In yet another embodiment, the level shift circuit 202 is positioned the amplifier 206 and the ADC 208 and frequency discriminator 210.

In one embodiment, the buffer 204 is positioned between the sensor output 112 and the level shift circuit 202. In such an embodiment, the buffer 204 is an impedance matching circuit that allows the conditioner 104 to respond to the sensor output 112 without loading the sensor 102 and, thereby, affecting the sensor output 112. In another embodiment, the conditioner 104 is configured for direct connection to the sensor 102 without the buffer 204. For example, in one such embodiment the conditioner 104 and/or the amplifier 206 have a high input impedance.

The output of the amplifier 206 is connected to the analog-to-digital converter (ADC) 208. The ADC 208 converts the varying voltage input to a digital value. The ADC 208 outputs a digital value that corresponds to the amplitude of the input at the time that the ADC 208 samples the input. In one embodiment, the ADC 208 has a sampling rate that corresponds to approximately twice the maximum frequency detected by the sensor 102. That is, the ADC 208 samples at the Nyquist rate. In this way the ADC 208 has a digital output 114-A that represents the output 112 of the sensor 102.

The frequency discriminator 210 is parallel to the analog-to-digital converter (ADC) 208. The frequency discriminator 210 measures the period of the signal from the sensor 102. The frequency discriminator 210 converts the period to an output 114-B that corresponds to the frequency of the output 112 of the sensor 102.

The processor 106 receives the outputs 114-A, 114-B from the conditioner 104 to determine the detected frequency and amplitude from the sensor 102. In one embodiment, the processor 106 has two inputs, each connected to one of the two outputs 114-A, 114-B from the conditioner 104. In another embodiment, the conditioner 104 does not include a frequency discriminator 210 and the processor 106 determines the measured frequency from the output 114-A of the ADC 208. In yet another embodiment, the conditioner 104 does not include an analog-to-digital converter 208 and the function of the ADC 208 is performed by the processor 106. Those skilled in the art will recognize that various types of analog-to-digital converters 208 and frequency discriminators 210 communicating with and/or incorporated in a processor 106 can be used without departing from the spirit and scope of the present invention.

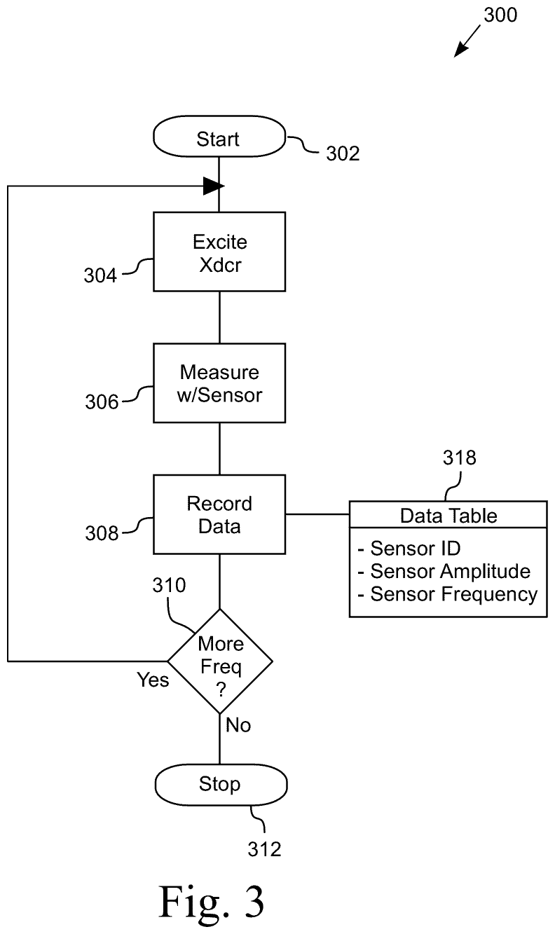

FIG. 3 illustrates a flow diagram one embodiment of the initializing process 300 for creating a data table 318 for monitoring the performance of an ultrasonic transducer 122. The table 318 is a base, or initial, table of data that contains the baseline data for a specific performance monitor 100 and associated ultrasonic transducer 122. The table 318 provides a baseline used by the monitoring system 100 to determine the performance of a particular embodiment of the transducer 122 after the transducer 122 is deployed. The data table 318 includes information for each sensor 102-A, 102-B that the monitor 100 uses to determine the performance and condition of a corresponding transducer 122 when the transducer 122 is monitored after deployment.

For a specific configuration of transducer 122 and sensor 102, a data table 318 is created that contains data identifying the sensor, the sensor amplitude at a measured frequency, and the sensor's measured frequency. In one embodiment, the process 300 is run as part of the manufacturing process and is stored in the processor 106 when specific units are manufactured. In another embodiment, the process 300 is run after a particular unit is manufactured, with the process 300 run before the unit is placed in service.

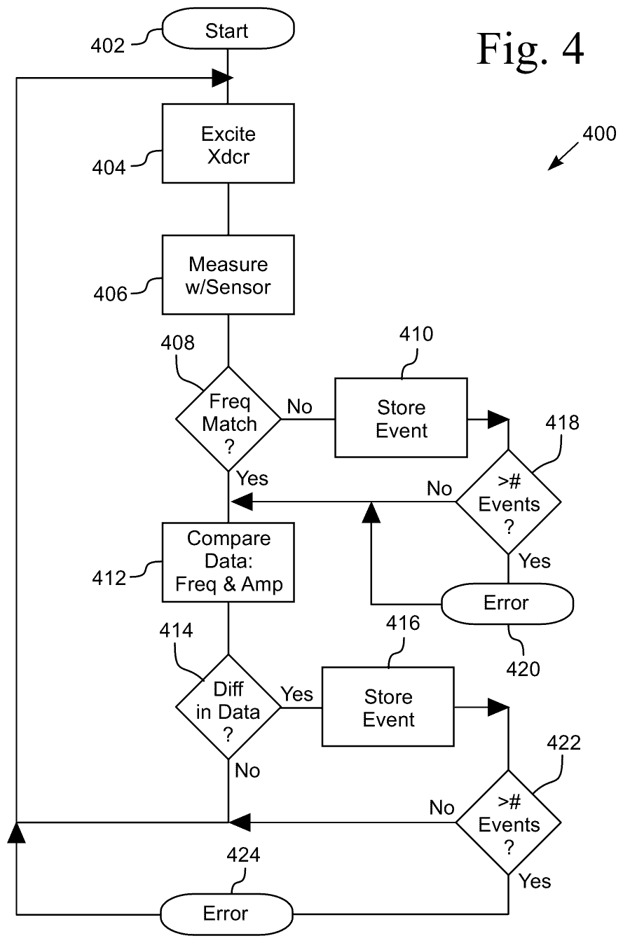

The first step 302 is to start the process 300. The start step 302 is performed before the monitoring process 400 illustrated in FIG. 4 is performed.

After the starting step 302, the step 304 of exciting the transducer 122 is performed. This step 304 includes the processor 108 sending an appropriate signal to the exciter 124, which then causes the transducer 122 to emit ultrasonic waves at a selected frequency and amplitude. The processor 106 controls the frequency and amplitude of the ultrasonic waves emitted by the transducer 122.

While the step 304 of exciting the transducer 122 is being performed, the step 306 of measuring with the sensor 102 is performed. In step 306, each of the sensors 102-A, 102-B measure parameters that are related to the parameters of the ultrasonic vibrations of the block 504 associated with the each of the sensors 102-A, 102-B. In one embodiment, the parameters include a frequency and an amplitude. Step 406 includes sending the measured parameters to the processor 106.

After acquiring the parameters in step 306, the next step 308 of recording the measured parameters in the data table 318 is performed. For each one of the sensors 102-A, 102-B, the sensor identification, the measured amplitude for that sensor at the excited frequency, and the measured frequency are recorded in the data table 318.

The next step 310 is to determine if more frequencies are to be excited. The transducer 122 is configured to emit a multitude of frequencies of ultrasonic waves. The data table 318 records data for each of these multitude of frequencies. If the step 310 determines that another frequency is to be measured by the sensor 102, then the process 300 loops back to step 304 to excite the transducer 122 with another frequency.

If step 310 determines that there no more frequencies to measure, the nest step 312 is to stop the process 300. The transducer 122 is now ready to be placed in service, along with the associated performance monitor 100.

FIG. 4 illustrates a flow diagram one embodiment of the monitoring process 400 for monitoring performance of an ultrasonic transducer 122. During operation of the performance monitoring system 100, the steps illustrated in FIG. 4 following the first step 402 to start are performed for each frequency emitted by the transducer 122. The first step 402 to start the monitoring system 100 occurs when operation of the transducer 122 is start when the transducer 122 is placed in service.

The second step 404 is to excite the transducer 122. This step 404 is performed by the processor 108 sending an appropriate signal to the exciter 124, which then causes the transducer 122 to emit ultrasonic waves at a selected frequency and amplitude. The processor 106 controls the frequency and amplitude of the ultrasonic waves emitted by the transducer 122. The processor 106, in one embodiment, determines the order of the various frequencies emitted by the transducer 122, as well as duty cycle and duration of emissions from the transducer 122.

While the step 404 of exciting the transducer 122 is being performed, the step 406 of measuring with the sensor 102 is performed. In this step 406, each of the sensors 102-A, 102-B measure parameters that are related to the parameters of the ultrasonic vibrations of the block 504 associated with each of the sensors 102-A, 102-B. In one embodiment, the parameters include a frequency and an amplitude. Step 406 includes sending the measured parameters to the processor 106.

The next step 408 is to determine if there is a frequency match between the sensor measurement and the desired transducer 102 emitted frequency. The processor 106 controls the desired transducer 102 emitted frequency. Step 408 compares the measured frequency from the sensor 102 to the desired transducer frequency. The determination that the measured and desired frequencies match is based on criteria programmed in the processor 106. In one embodiment, the measured and desired frequencies match if they are the same. In another embodiment, the measured and desired frequencies match if they are within a defined tolerance. In one such embodiments, the tolerance is defined as a difference between the measured and desired frequency, for example, the measured frequency is within 10 Hz of the desired frequency. In another such embodiment, the tolerance is a percentage of the desired frequency, for example, the measured and desired frequencies are within plus-or-minus one percent.

If the measured and desired frequencies do not match based on the specified criteria, the next step 410 is store an event. An event is a record identifying when the sensor 102 measures an out-of-specification or out-of-tolerance condition. The out-of-tolerance condition is when frequency is not within tolerance. This step 410 records the date and time, the measured frequency and amplitude, and the desired frequency. The next step 418 is to determine if the number of events within a period exceeds a maximum value. If so, then the next step 420 is to indicate an error. In the illustrated embodiment, after the error step 420 indicates/records the error, the process continues with the next step 412 of comparing the data is performed. In another embodiment, the process stops and the transducer is taken out of service. If the measured and desired frequencies match based on the specified criteria, the next step 412 of comparing the data is performed.

Step 412 to compare the data is performed. This step 412 includes retrieving the data table parameters from the data table for the expected frequency and amplitude. The step 412 also includes comparing amplitude with the data retrieved from the data table.

Step 414 determines if there is an actionable difference between the measured parameters and the data table parameters, that is, step 414 determines if the measured parameters and the data table parameters not match based on the specified criteria. If the measured parameters and the data table parameters match based on the specified criteria, that is, there is no actionable difference, the process loops to the next step 404 where the transducer 122 is excited again.

For step 414, if the measured parameters and the data table parameters do not match based on the specified criteria, that is, there is an actionable difference, step 416 to store the event is performed. The event is a record identifying when the sensor 102 measures an out-of-specification or out-of-tolerance condition. The out-of-tolerance condition is when the sensor 102 measured parameters and the data table parameters do not match based on the specified criteria. Step 410 records an event that includes the date and time, the measured frequency and amplitude, and the desired data table information. The next step 422 is to determine if the number of events within a period exceeds a maximum value. If so, then the next step 424 is to indicate an error. In the illustrated embodiment, after the error step 424 indicates/records the error, the process loops to the next step 404 where the transducer 122 is excited again.

FIG. 5 illustrates a side view of one embodiment of an ultrasonic transducer 122-1 showing a first embodiment of a sensor arrangement 500-1 with a pair of sensors 102-1A, 102-1B each coupled to a side face 506 of the blocks 504-1A, 504-1B. FIG. 6 illustrates an exploded side view of the embodiment of FIG. 5.

The illustrated embodiment of the transducer 122-1 includes a piezoelectric crystal 502 and a pair of blocks 504-1A, 504-1B. The piezoelectric element or crystal 502 is sandwiched between the pair of blocks 504-1A, 504-1B with the crystal 502 compressed therebetween by a fastener 510. The piezoelectric element or crystal 502 is acoustically coupled to the pair of blocks 504-1A, 504-1B so that vibratory energy is transmitted from the element 502 to the pair of blocks 504-1A, 504-1B. The piezoelectric crystal 502 has opposing faces 502f that engage the blocks 504-1A, 504-1B. As shown in the embodiment illustrated in FIG. 6, each block 504 has a recess 702 sized to receive a corresponding face 502f of the crystal 502. In the illustrated embodiment, the transducer 122-1 does not rely on an adhesive to ensure a good electrical and mechanical contact between the blocks 504-1A, 504-1B and piezoelectric crystal or element 502. Instead, the illustrated embodiment of the transducer 122-1 relies upon the compression from the fastener 510 to ensure a good electrical and mechanical contact between the blocks 504-1A, 504-1B and piezoelectric element 502.

In the illustrated embodiment, the fastener 510 includes a bolt 512 having a head 612 and a shaft 616 that is threaded to receive a nut 514. The illustrated embodiment includes a first washer 516 adjacent the bolt head 612 and a first insulated shoulder washer 614 adjacent the first washer 516. The first shoulder washer 614 insulates the bolt 512 from the first block 504-1A. The illustrated embodiment also includes a second washer 518 adjacent the distal end of the threaded shaft 616 and a second insulated shoulder washer 616 adjacent the second washer 518. The second shoulder washer 616 insulates the bolt 512 from the second block 504-1B. The insulated washers 614, 616 insulates the fastener 510 from the pair of blocks 504-1A, 504-1B. In this way, independent electrical connections 126 to the blocks 504-1A, 504-1B allow the crystal 502 to be excited with the ultrasonic energy conducted from the crystal 502 to the blocks 504-1A, 504-1B and then beyond as ultrasonic waves.

In the illustrated embodiment, a pair of sensors 102-1A, 102-1B are affixed to a side face or a surface 506 of the blocks 504-1A, 504-1B. Each sensor 102-1A, 102-1B is a piezoelectric crystal, such as one having a disk shape. The sensors 102-1A, 102-1B are attached to the block face 506 with an adhesive 522 such that a face of the sensor 102-1A, 102-1B has a mechanical connection with the block 504-1A, 504-1B. In this way, each sensor 102-1A, 102-1B is responsive to the integrity of the connection of a face 502f of the piezoelectric element 502 to the corresponding block 102-1A, 102-1B. If the connection between the element 502 and the block 504 is compromised, such as a loose fastener 510 or a cracked element 502, the sensor 102 will measure a change in the frequency or amplitude from the initial data.

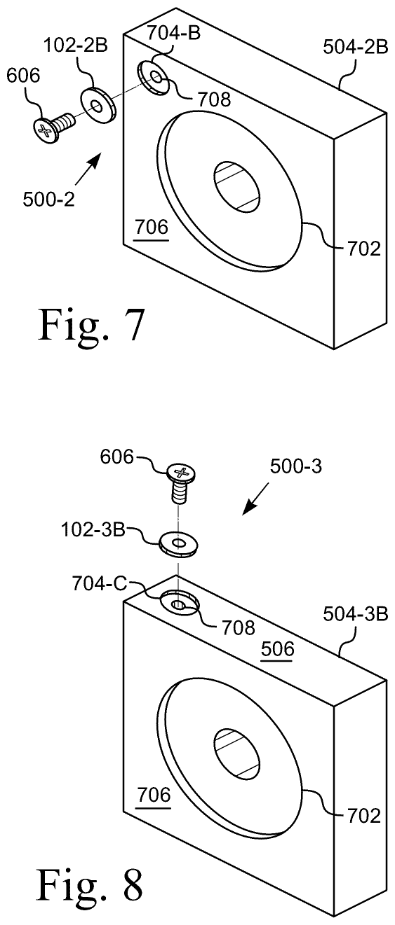

FIG. 7 illustrates a perspective, exploded view of a second embodiment of a sensor arrangement 500-2 with a sensor 102-2B coupled to a rear face 706 of a block 504-2B. The block 504-2B has a recess 702 defined on the inside surface 706 of the block 504-2B. The recess 702 is sized and dimensioned to receive a face 502f of the piezoelectric crystal 502.

In the illustrated embodiment, the sensor 102-2B has a donut-shape with a central opening that receives a screw 606. The screw 606 engages a threaded opening 708 in a sensor recess 704-B on the inside face 706 of the block 504-2B. The sensor recess 704-B is sized and dimensioned to receive the sensor 102-2B. The screw 706 secures the sensor 102-2B to the block 504-2B with a mechanical connection that allows the sensor 102-2B to receive vibrations from the block 504-2B.

FIG. 8 illustrates a perspective, exploded view of a third embodiment of a sensor arrangement 500-3 with a sensor 102-3B and its coupling to a block 504-3B. The block 504-3B has a recess 702 defined on the inside surface 706 of the block 504-3B. The recess 702 is sized and dimensioned to receive a face 502f of the piezoelectric crystal 502.

In the illustrated embodiment, the sensor 102-3B has a donut-shape with a central opening that receives a screw 706. The screw 706 engages a threaded opening 708 in a sensor recess 704-C on the side face 506 of the block 504-3B. The sensor recess 704-C is sized and dimensioned to receive the sensor 102-3B. The screw 706 secures the sensor 102-3B to the block 504-3B with a mechanical connection that allows the sensor 102-3B to receive vibrations from the block 504-3B.

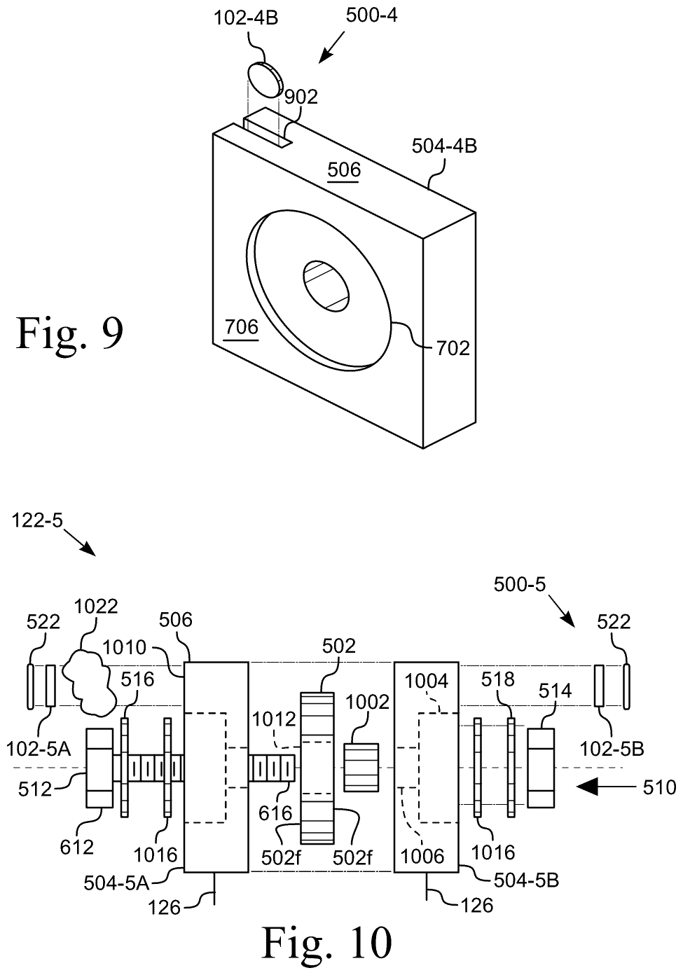

FIG. 9 illustrates a perspective, exploded view of a fourth embodiment of a sensor arrangement 500-4 with a sensor 102-4B coupled inside a block 504-4B. The block 504-4B has a recess 702 defined on the inside surface 706 of the block 504-4B. The recess 702 is sized and dimensioned to receive a face 502f of the piezoelectric crystal 502.

In the illustrated embodiment, the sensor 102-4B has a disc-shape to slides into a slot 902 in the side 506 of the block 504-4B. In the illustrated embodiment, the slot 902 is positioned in a corner of the block 504-4B. In another embodiment, the slot 902 is positioned away from the corner. In such an embodiment, the slot 902 is a blind slot with an opening on only one side 506 of the block 504-4B.

In one embodiment, the sensor 102-4B is secured in the slot 902 with an adhesive 522. The adhesive 522 acoustically couples the sensor 102-4B to the block 504-3B such that the sensor 102-4B receives vibrations from the block 504-4B.

FIG. 10 illustrates an exploded view of a fifth embodiment of a sensor arrangement 500-5 with a pair of sensors 102-5A, 102-5B positioned adjacent the outer faces of the blocks 504-5A, 504-5B of the transducer 122-5.

The transducer 122-5 includes a pair of blocks 504-5A, 504-5B with a piezoelectric element 502 sandwiched therebetween. Each block 504-5 includes a through-hole 1006 that receives the shaft 616 of a bolt 512. Each block 504-5 includes a recess 1004 that receives the washers 1016, 516 and either the bolt head 612 or the nut 514. The recesses 1004 are sized such that the ends of the fastener 510 do not protrude beyond the outer face, or surface, 1010 of the blocks 504-5A, 504-5B. In one embodiment, the blocks 504-5A, 504-5B include recesses 702 sized and dimensioned to receive a face 502f of the piezoelectric crystal 502.

A bushing 1002 fits over the shaft 606 and inside a through-opening 1012 in the element 502. The bushing is insulated such that there is no direct electrical continuity between the element 502 and the bolt 512. The washers 1016 are insulated such that there is no direct electrical continuity between the blocks 504-5A, 504-5B and the bolt 512.

The illustrated sensor arrangement 500-5 includes a sensor 102-5A, 102-5B adjacent an outer face 1010 of each block 504-5A, 504-5B. The sensors 102-5A, 102-5B are attached to an inside surface of the housing 1102 with an adhesive 522. The sensors 102-5A, 102-5B are acoustically coupled to the blocks 504-5A, 504-5B by a potting compound 1022 that is acoustically transparent to the ultrasonic vibrations from the blocks 504-5A, 504-5B. The potting compound 1022 fills in the space around the transducer 122-5 bounded by the cavity 1112 in the housing 1102.

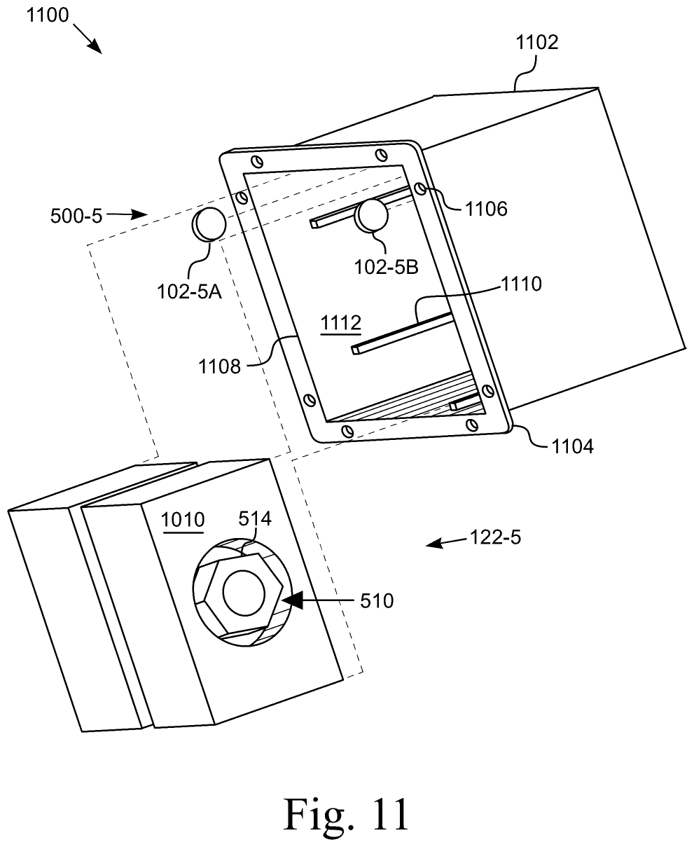

FIG. 11 illustrates an exploded view of a fifth embodiment of a sensor arrangement 500-5 with a pair of sensors 102-5A, 102-5B positioned to attach to a transducer housing 1102 positioned to receive the transducer 122-5. The pair of sensors 102-5A, 102-5B are coupled to corresponding ones of the pair of blocks 504-1A, 504-1B by way of a potting compound 1022. The housing 1102 and transducer 122-5 together form part of a sonic head 1100, which is configured to be suspended in a body of water.

In the illustrated embodiment, the housing 1104 has five sides that define a cavity 1112 that receives the transducer 122-5. The open end of the housing 1104 has a flange 1104 with openings 1106 that receive fasteners. The flange 1104 is configured to attach to a second housing of the sonic head 1100. In one embodiment, the second housing includes the conditioners 104, the exciter 124, and the processor 106. The opposite end of the housing 1104 includes a hanger or attachment point (not illustrated) configured to allow the housing 1104 to be suspended below the surface of a body of water.

The inside surfaces 1108 of the housing 1102 include standoffs 1110 that engage the various surfaces of the transducer 122-5. The standoffs 1110 space the sides 506, 1010 of the blocks 504-5A, 504-5B away from the inside surfaces 1108 of the housing 1102. The gap between the surfaces 506, 1010 of the blocks 504-5A, 504-5B and the inside surfaces 1108 of the housing 1102 is filled with potting compound 1022. The potting compound 1022 encapsulates and protects the transducer 122-5 and sensors 102-5A, 102-5B from the water environment surrounding the sonic head 1100.

The sensor arrangement 500-5 includes two sensors 102-5A, 102-5B. Each sensor 102-5A, 102-5B is attached to an inside surface 1108 of the housing 1102 in a location where the sensor 102-5A, 102-5B is responsive to ultrasonic vibrations emanating from the adjacent block 504-5A, 504-5B. In the illustrated embodiment, the sensors 102-5A, 102-5B are adjacent an outer face 1010 of the blocks 504-5A, 504-5B. In other embodiments, the sensors 102-5A, 102-5B are adjacent a side 506 of the blocks 504-5A, 504-5B. In the illustrated embodiment, the sensors 102-5A, 102-5B are attached directly to the inside surface 1108 with an adhesive 522. In another embodiment, the sensors 102-5A, 102-5B engage a recess in the housing 1102, similar to the recesses 708 illustrated in FIGS. 7 & 8, with the sensors 102-5A, 102-5B secured in the recesses with an adhesive 522.

With the sensors 102-5A, 102-5B secured inside the cavity 1112 of the housing 1112, the transducer 122-5 is positioned inside the cavity 1112 with potting compound 1012 filing the space between the transducer 122-5 and the housing 1112. The wiring 112-A, 112-B, 126 associated with the sensors 102-5A, 102-5B and transducer 122-5 extends past the flange 1104 of the housing 1104 and out of the cavity 1112.

The performance monitor 100 includes various functions. The function of monitoring the interface between the piezoelectric element or crystal 502 and the block 504 is implemented, in one embodiment, by a sensor 102 acoustically coupled to the block 504 such that sensor 102 is responsive to ultrasonic vibrations emitted from the crystal 502 to the block 504.

The function of acoustic coupling the sensor 102 to a block 504 is implemented, in one embodiment, by affixing the sensor 102 to the block 504 such as illustrated in FIGS. 5-9. In another embodiment, the function of acoustic coupling the sensor 102 to a block 504 is implemented by affixing the sensor 102 to a housing 1102 proximate the block 504 such as illustrated in FIG. 10. Acoustic coupling is defined as a connection that has a low impedance to vibrations, such as mechanical vibrations, in the ultrasonic range that includes the frequencies emitted by the transducer 122. The ultrasonic waves are produced from mechanical vibrations of the excited piezoelectric element 502. For example, in one embodiment, the transducer 122 emits ultrasonic waves up to frequencies measured in the hundreds of kilohertz. In another embodiment, the transducer 122 emits ultrasonic waves up to frequencies measured in low megahertz.

The function of acoustic coupling the sensor 102 to a block 504 is implemented, in one embodiment, by adhering the sensor 102 to the block 504 such as illustrated in FIGS. 5, 6 & 9. In another embodiment, the function of acoustic coupling the sensor 102 to a block 504 is implemented by adhering the sensor 102 to a housing 1102 proximate the block 504 such as illustrated in FIG. 10. The function of acoustic coupling the sensor 102 to a block 504 is implemented, in yet another embodiment, by attaching the sensor 102 to the block 504 with a fastener 606 such as illustrated in FIGS. 7 & 8.

The function of determining if the transducer 122 is functioning properly is implemented, in one embodiment, by measuring 406 the transducer parameters and determining 408 if the measured frequency matches the desired frequency, such as illustrated in FIG. 4. In another embodiment, the function of determining if the transducer 122 is functioning properly is implemented, in one embodiment, by measuring 406 the transducer parameters and determining 412, 414 if the measured parameters match the data stored in a data table 318 such as illustrated in FIG. 4.

The function of determining 420, 424 if the transducer 122 has failed is implemented, in one embodiment, by comparing 418, 422 the number of events to a predetermined number such as illustrated in FIG. 4.

From the foregoing description, it will be recognized by those skilled in the art that a performance monitor 100 has been provided. The performance monitor 100 includes a sensor 102, a conditioner 104, and a processor 106. The sensor 102 is positioned such that the sensor 102 is acoustically responsive, for example, by being coupled directly or indirectly, to a block 504 that has an attached piezoelectric element 502. The processor 106 executes a process 400 that includes measuring 406 parameters when the transducer 122 is excited. Those parameters are evaluated 408, 412, 414 to determine 408, 414 if there is an event. An event is defined as a condition where one or more measured parameters are outside specified criteria. If there is an event, the number of events is compared 418, 422 to a predetermined number. If there are too many events, an error 420, 424 is indicated.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for monitoring performance of a transducer that includes a piezoelectric element and a first block coupled to said piezoelectric element, said apparatus comprising:
a first sensor that is responsive to ultrasonic vibrations from the first block;
a first conditioner in electrical communication with said first sensor; and
a processor in electrical communication with said first conditioner.

2. The apparatus of claim 1 wherein said first sensor is acoustically coupled to the first block.

3. The apparatus of claim 2 wherein said first sensor is acoustically coupled to the first block with an adhesive.

4. The apparatus of claim 2 wherein said first sensor is received in a recess in the first block.

5. The apparatus of claim 2 wherein said first sensor is received in a slot in the first block.

6. The apparatus of claim 2 wherein said first sensor is acoustically coupled to the first block with a fastener.

7. The apparatus of claim 2 further including a housing configured to receive the piezoelectric element and the first block, said housing including a potting compound securing the piezoelectric element and the first block when received in said housing, wherein said first sensor is acoustically coupled to the first block with an adhesive attached to a surface in said cavity of said housing, said first sensor positioned proximate a surface of the first block.

8. The apparatus of claim 1 wherein said processor executes a process that includes the steps of exciting the transducer, measuring at least one parameter with said sensor, evaluating said at least one parameter to determine if an event has occurred, and storing said event.

9. The apparatus of claim 8 wherein said event includes a date, a time, an identifier of said sensor, and data corresponding to said at least one parameter from said measuring step.

10. The apparatus of claim 8 wherein said event includes a date, a time, an identifier of said sensor, data corresponding to said at least one parameter from said measuring step, and data corresponding to at least one desired parameter.

11. The apparatus of claim 8 wherein said at least one parameter includes a measured frequency, said step of evaluating said measured frequency includes determining if said measured frequency matches an excitation frequency applied to said piezoelectric element.

12. The apparatus of claim 8 wherein said at least one parameter includes a measured frequency and a measured amplitude, and said step of evaluating said measured frequency and said measured amplitude includes steps of comparing said measured frequency and said measured amplitude to values stored in a data table.

13. The apparatus of claim 12 wherein said data table includes an amplitude for each one of a plurality of frequencies.

14. The apparatus of claim 8 wherein said process further includes a step determining if a number corresponding to said stored events exceeds a predetermined number.

15. The apparatus of claim 1 wherein said conditioner receives an analog input and has a digital output.

16. The apparatus of claim 1 wherein said conditioner includes an amplifier, a frequency discriminator circuit, and an analog-to-digital circuit (208).

17. The apparatus of claim 1 wherein said conditioner includes a level shifting circuit, an amplifier, a frequency discriminator circuit, and an analog-to-digital circuit.

18. An apparatus for performance monitoring, said apparatus comprising:
a transducer that includes a piezoelectric element and a first block acoustically coupled to said piezoelectric element;
a first sensor that is responsive to ultrasonic vibrations from said first block, said first sensor acoustically coupled to said first block;
a first conditioner in electrical communication with said first sensor; and
a processor in electrical communication with said first conditioner.

19. The apparatus of claim 18 further including a second block acoustically coupled to said piezoelectric element; a second sensor that is responsive to ultrasonic vibrations from said second block, said second sensor acoustically coupled to said second block; and a second conditioner in electrical communication with said second sensor and in electrical communication with said processor.

20. The apparatus of claim 18 wherein said first sensor is acoustically coupled to said first block with an adhesive.

21. The apparatus of claim 18 further including a housing configured to receive said piezoelectric element and said first block, said housing including a potting compound securing said piezoelectric element and said first block when received in said housing, wherein said first sensor is acoustically coupled to said first block with an adhesive attached to a surface in said cavity of said housing, said first sensor positioned proximate a surface of said first block.

22. The apparatus of claim 18 wherein said processor executes a process that includes the steps of exciting the transducer, measuring at least one parameter with said sensor, evaluating said at least one parameter to determine if an event has occurred, and storing said event.

23. An apparatus for monitoring performance of a transducer that includes a piezoelectric element and a first block coupled to said piezoelectric element, said apparatus comprising:
a first sensor that is responsive to ultrasonic vibrations from the first block; and
a processor in communication with said first sensor, said processor executing a process that includes the steps of exciting the transducer, measuring at least one parameter with said sensor, evaluating said at least one parameter to determine if an event has occurred, and storing said event, wherein said event records an out-of-tolerance condition.
